(19) United States
(12) Patent Application Publication
(10) Pub. No.: US 2014/0002303 A1
(43) Pub. Date: Jan. 2, 2014

(54) APPARATUS AND METHOD FOR HANDLING JAMMING SIGNAL

(71) Applicant: Electronics and Telecommunications Research Institute, (US)

(72) Inventors: Cheon Sig SIN, Daejeon (KR); Seong Kyun JEONG, Suwon-si Gyeonggi-do (KR); Sang Uk LEE, Daejeon (KR); Young Bak KIM, Daejeon (KR)

(73) Assignee: Electronics and Telecommunications Research Institute, Daejeon (KR)

(21) Appl. No.: 13/738,003

(22) Filed: Jan. 10, 2013

(30) Foreign Application Priority Data
Jun. 29, 2012 (KR) 10-2012-0071285

(51) Int. Cl. G01S 19/21

(52) U.S. Cl. CPC G01S 19/21
USPC 342/357.59

(57) ABSTRACT

The apparatus includes a first frequency conversion unit that converts a radio frequency (RF) signal of a first satellite into an intermediate frequency (IF) signal, a signal processing unit that acquires signal processing information by performing signal tracking with respect to the converted IF signal, a jamming determination unit that determines whether a jamming signal is generated based on the acquired signal processing information, and a signal complex processing unit that performs signal processing with respect to an RF signal of a second satellite based on the signal processing information to thereby generate a navigation message of the first satellite when the jamming signal is generated. Accordingly, a Global Positioning System (GPS) receiver that is installed in a fixed point may acquire stable visual information even in an environment in which a jamming signal is generated.

### CLAIM FOR PRIORITY

This application claims priority to Korean Patent Application No. 10-2012-0071285 filed on Jun. 29, 2012 in the Korean Intellectual Property Office (KIPO), the entire contents of which are hereby incorporated by reference.

### BACKGROUND

1. Technical Field

Example embodiments of the present invention relate in general to a technology for handling jamming signals and more specifically to an apparatus and method for handling jamming signals which may effectively deal with jamming signals generated in a frequency band of the Global Positioning System (GPS).

2. Related Art

A visual information providing device which is used in a mobile communication base station and the like performs system synchronization using a Global Positioning System (GPS) receiver. In addition, the visual information providing device is configured in such a manner that timing signals of time of date (TOD), one pulse per second (1 PPS), and 10 MHz are provided to the mobile communication base station and the like.

In addition, when receiving signals from a GPS satellite through a GPS antenna, the visual information providing device demodulates the received signals using the GPS receiver to thereby produce timing signals of TOD, 1 PPS, and 10 MHz.

Meanwhile, the GPS receiver of the visual information providing device receives navigation signals to acquire visual information, and when GPS radio frequency (RF) signals are jammed, stable visual information cannot be acquired, and therefore much research on how to deal with this problem has been conducted.

For example, in order to deal with the jammed GPS RF signals, a technique in which an internal oscillator generating clocks is installed in a system itself, and visual information is generated through the installed internal oscillator has been used. However, in this technique, performance degradation occurs along with an increase in an operating duration time of the internal oscillator, and therefore there is a visual synchronization problem between systems due to the occurrence of the performance degradation.

In addition, in order to deal with the jammed GPS RF signals, a technique for performing visual synchronization using long range navigation-C (Loran-C) has been used. The technique for performing visual synchronization using Loran-C may provide high frequency accuracy and visual synchronization performance for terrestrial signals designed for navigation mainly along coasts using a subcarrier frequency of 100 kHz band. However, a separate additional device is required in order to utilize Loran-C due to a different system.

In addition, in order to deal with the jammed GPS RF signals, a technique for measuring a group delay error in a combined GPS/GLONASS receiver has been used. However, there is a problem that there are many differences between the technique for measuring the group delay error in the combined GPS/GLONASS receiver and GPS visual information provision as a method for compensating for the group delay errors in the GPS/GLONASS receiver.

### SUMMARY

Accordingly, example embodiments of the present invention are provided to substantially obviate one or more problems due to limitations and disadvantages of the related art.

Example embodiments of the present invention provide an apparatus for handling jamming signals, which may effectively deal with jamming in a frequency band of the Global Positioning System (GPS).

Example embodiments of the present invention also provide a method for handling jamming signals using the apparatus for handling jamming signals.

In some example embodiments, an apparatus for handling jamming signals includes: a first frequency conversion unit that converts a radio frequency (RF) signal of a first satellite into an intermediate frequency (IF) signal; a signal processing unit that acquires signal processing information by performing signal tracking with respect to the converted IF signal; a jamming determination unit that determines whether a jamming signal is generated based on the acquired signal processing information; and a signal complex processing unit that performs signal processing with respect to an RF signal of a second satellite based on the signal processing information to thereby generate a navigation message of the first satellite when the jamming signal is generated.

Here, the apparatus may further include a reception unit that receives the RF signal of the first satellite and the RF signal of the second satellite; a signal distribution unit that provides the RF signal of the first satellite and the RF signal of the second satellite; a switching unit that performs switching with respect to the RF signal of the first satellite and the RF signal of the second satellite based on a control of the jamming determination unit; and a second frequency conversion unit that converts the navigation message of the first satellite into an RF signal.

Here, the signal processing unit may perform the signal tracking with respect to the converted IF signal, acquire the signal processing information including at least one of code phase information, subcarrier phase information, navigation message information, Doppler frequency, and timing information by utilizing the navigation message and a ranging signal, and provide the acquired signal processing information.

Here, the signal complex processing unit may convert the RF signal of the second satellite into an IF signal, acquire timing offset information between the RF signal of the second satellite and the RF signal of the first satellite, and generate the navigation message of the first satellite including at least one of time of week (TOW), transmission week no (WN), epoch for ephemeris & SV clock parameters (toe), signal health, an ephemeris & SV clock packet, and an ionospheric correction parameter packet based on position information of the first satellite stored before the acquired timing offset information and the jamming signal are generated.

Here, the jamming determination unit may control the switching unit so that the RF signal of the first satellite is provided to the first frequency conversion unit when the jamming signal is not generated, and control the switching unit so that the RF signal of the second satellite is provided to the signal complex processing unit when the jamming signal is generated.

In other example embodiments, a method for handling jamming signals which is performed in an apparatus for handling jamming signals, includes: converting an RF signal of a first satellite into an IF signal; acquiring signal processing information by performing signal tracking with respect to the converted IF signal; determining whether a jamming signal is generated based on the acquired signal processing information; and performing signal processing with respect to an RF signal of a second satellite based on the signal processing information to thereby generate a navigation message of the first satellite when the jamming signal is generated.

Here, the method may further include receiving the RF signal of the first satellite and the RF signal of the second satellite; distributing the RF signal of the first satellite and the RF signal of the second satellite; performing switching with respect to the distributed RF signal of the first satellite and the distributed RF signal of the second satellite; and converting the navigation message of the first satellite into an RF signal.

Here, the determining may include performing the signal tracking with respect to the converted IF signal, acquiring the signal processing information including at least one of code phase information, subcarrier phase information, navigation message information, Doppler frequency, and timing information by utilizing the navigation message and a ranging signal, and determining whether the jamming signal is generated based on the acquired signal processing information.

Here, the performing of the signal processing may include converting the RF signal of the second satellite into an IF signal, acquiring timing offset information between the RF signal of the second satellite and the RF signal of the first satellite, and generating the navigation message of the first satellite including at least one of TOW, transmission WN, epoch for ephemeris & SV clock parameters (toe), signal health, an ephemeris & SV clock packet, and an ionospheric correction parameter packet based on position information of the first satellite stored before the acquired timing offset information and the jamming signal are generated.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram showing an operation environment of an apparatus for handling jamming signals according to an embodiment of the present invention;

FIG. 2 is a block diagram showing a configuration of an apparatus for handling jamming signals according to an embodiment of the present invention; and

FIG. 3 is a flowchart showing a process for handling jamming signals which is performed in an apparatus for handling jamming signals according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

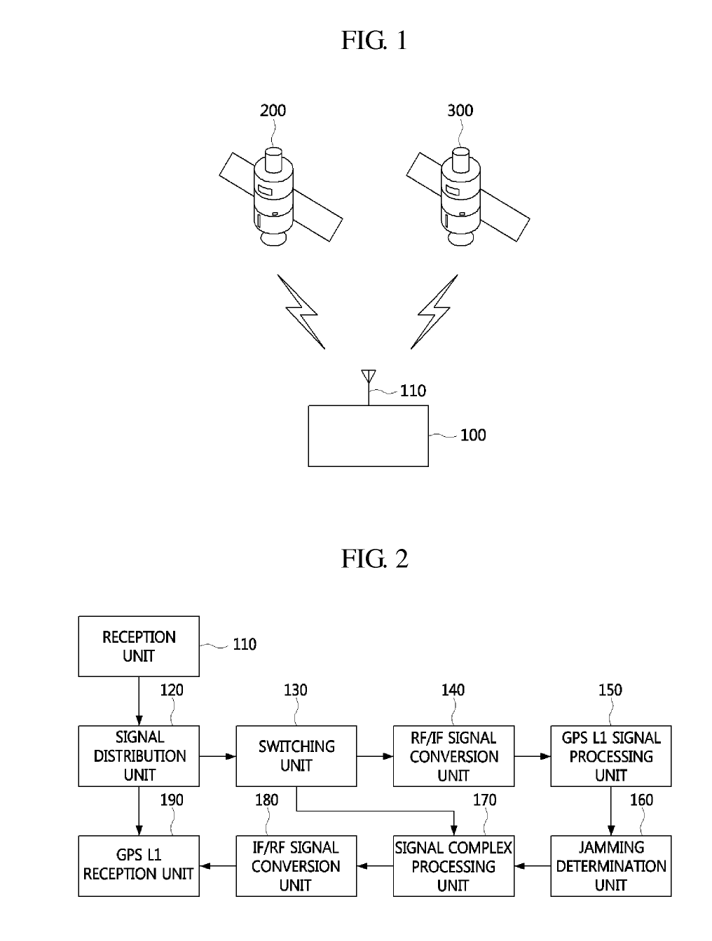

FIG. 1 is a conceptual diagram showing an operation environment of an apparatus for handling jamming signals according to an embodiment of the present invention.

Referring to FIG. 1, an operation environment of an apparatus 100 for handling jamming signals may include the apparatus 100 for handling jamming signals, a Global Positioning System (GPS) satellite 200, and a GLONASS satellite 300.

Here, the GPS satellite is a satellite that is used in a positioning system of the United States, and the GLONASS satellite is a satellite that is used in a positioning system of Russia. In addition, the jamming signals are interference signals which are sent in a frequency within a data reception band.

When a jamming signal preventing a navigation signal sent by the GPS satellite 200 from being received is generated, the apparatus 100 provides satellite ephemeris for the GPS satellite, visual information, and the like as a radio frequency (RF) signal to a GPS navigation reception unit that is installed in a base station or the like, by utilizing GLONASS navigation signals having a different navigation system, and therefore synchronization or the like between systems within the apparatus 100 may be performed through the installed reception unit 110.

Here, the apparatus 100 may include an appropriate logic, circuit and/or code which enables RF signals broadcast from the GPS satellite 200 and the GLONASS satellite 300 to be received.

Here, the GPS satellite 200 and the GLONASS satellite 300 may include appropriate logics, circuits and/or codes that enable appropriate RF signals received by a satellite receiver such as a visual information providing device to be generated and broadcast. In addition, the generated appropriate RF signals may be used so as to determine navigation information such as position, speed, and visual information of the apparatus 100.

According to an embodiment of the present invention, an example utilizing the GPS satellite and the GLONASS satellite has been described, but according to another embodiment of the present invention, Galileo satellite of Europe, Beidu satellite of China, COMPASS satellite of China, or the like may be utilized rather than the GPS satellite and the GLONASS satellite.

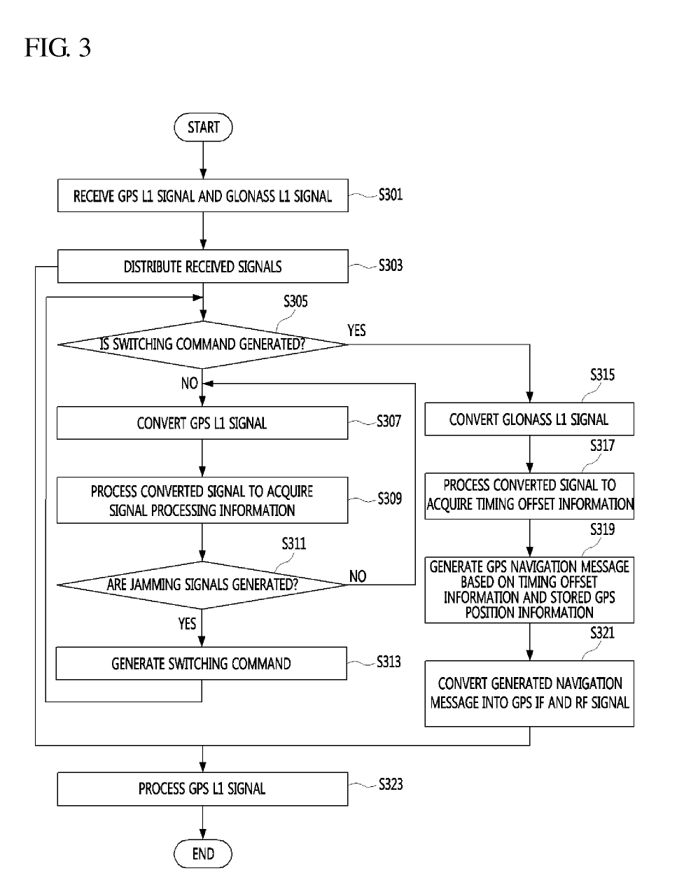

FIG. 2 is a block diagram showing a configuration of an apparatus for handling jamming signals according to an embodiment of the present invention.

Referring to FIG. 2, the apparatus according to an embodiment of the present invention may include a reception unit that receives GPS L1 (1575.42 MHz) signals and GLONASS L1 (1602 MHz) signals, a signal distribution unit 120 that provides RF signals, a switching unit 130 that performs switching, an RF/IF signal conversion unit 140 that converts the RF signals into Intermediate Frequency (IF) signals and digital signals, a GPS L1 signal processing unit 150 that processes GPS L1 band navigation signals, a jamming determination unit 160 that determines whether jamming in the GPS L1 band is generated, a signal complex processing unit 170 that performs complex processing of GPS L1/GLONASS L1 signals, and processes timing offset between a GPS navigation system and a GLONASS navigation system, an IF/RF signal conversion unit 180 that converts the generated signals into IF and RF signals, and a GPS L1 reception unit 190 that receives the RF signals to acquire visual information.

Specifically, the reception unit 110 receives GPS L1 signals and GLONASS L1 signals, and provides the received GPS L1 signals and GLONASS L1 signals to the signal distribution unit 120.

Here, the reception unit 110 may include an appropriate logic, circuit and/or code that enables the GPS L1 signals and GLONASS L1 signals to be received.

The signal distribution unit 120 provides, to each of the switching unit 130 and the GPS L1 reception unit 190, the GPS L1 signals and/or GLONASS L1 signals provided from the reception unit 110.

The switching unit 130 may provide, to the RF/IF signal conversion unit 140 or the signal complex processing unit 170, the GPS L1 signals and/or GLONASS L1 signals provided from the signal distribution unit 120 depending on information as to whether a switching command is received. That is, when the switching command is not received from the jamming determination unit 160, the switching unit 130 may provide, to the RF/IF signal conversion unit 140, the GPS L1 signals and/or GLONASS L1 signals provided from the signal distribution unit 120.

Alternatively, when the switching command is received from the jamming determination unit 160, the switching unit 130 may provide, to the signal complex processing unit 170, the GPS L1 signals and/or GLONASS L1 signals provided from the signal distribution unit 120.

The RF/IF signal conversion unit 140 converts the GPS L1 signals received from the switching unit 130 into IF signals and digital signals to thereby provide the converted IF and digital signals to the GPS L1 signal processing unit 150 so that the GPS L1 signals received from the switching unit 130 are processed by the GPS L1 signal processing unit 150.

The GPS L1 signal processing unit 150 receives the IF and digital signals from the RF/IF signal conversion unit 140, performs signal tracking with respect to the received IF and digital signals, and then acquires signal processing information including code phase information, subcarrier phase information, navigation message information, Doppler frequency, timing information, and the like by utilizing a navigation message and ranging signals.

The GPS L1 signal processing unit 150 provides the acquired signal processing information to the jamming determination unit 160.

The jamming determination unit 160 determines whether the jamming signal is generated based on the signal processing information received from the GPS L1 signal processing unit 150, and provides the signal processing information to the signal complex processing unit 170 when the jamming signal is determined to be generated.

Here, when the received signal processing information includes an existing data range, the jamming determination unit 160 determines that the jamming signal is not generated, and when the received signal processing information does not include the existing data range, the jamming determination unit 160 determines that the jamming signal is generated.

The signal complex processing unit 170 processes GLONASS L1 signals in accordance with the signal processing information received from the jamming determination unit 160, and performs GPS/GLONASS timing offset processing with respect to timing information for GLONASS navigation signals to thereby generate a GPS navigation message.

That is, the signal complex processing unit 170 performs a function of acquiring timing offset information between GPS and GLONASS based on the timing information acquired by processing the GLONASS L1 signals.

In addition, the signal complex processing unit 170 processes the timing offset processing result between GPS and GLONASS together with position information with respect to a GPS receiver installed in a fixed position such as a base station or the like which is stored before the jamming signals are generated, and generates a GPS navigation message including time of week (TOW), transmission week no (WN), epoch for ephemeris & SV clock parameters (toe), signal health, an ephemeris & SV clock packet, an ionospheric correction parameter packet, and the like based on the position information.

Here, in order to obtain only accurate timing information in the GPS L1 reception unit 190 installed in a fixed position such as a base station, the signal complex processing unit 170 inserts a minimum of four pieces of imitation satellite information based on a disposition of a satellite so that dilution of precision (DOP) of an available satellite with respect to satellite ephemeris information, satellite health state, and the like is superior, generates the navigation message including the timing information acquired from the GLONASS L1 signals, and provides the generated navigation message to the IF/RF signal conversion unit 180.

Here, the DOP of the available satellite is information about satellite disposition rather than information about an actual visible satellite.

The IF/RF signal conversion unit 180 converts the GPS navigation message provided from the signal complex processing unit 170 into IF and RF signals, and provides the converted IF and RF signals to the GPS L1 reception unit 190 through an RF cable.

Therefore, according to the apparatus for handling jamming signals according to an embodiment of the present invention, stable visual information may be acquired even in an environment in which jamming signals are generated, through the GLONASS L1 signals having a different navigation system in addition to a frequency band used by the GPS L1 signals.

FIG. 3 is a flowchart showing a process for handling jamming signals which is performed in an apparatus for handling jamming signals according to an embodiment of the present invention.

Referring to FIG. 3, in step S301, the apparatus receives GPS L1 and GLONASS L1 signals. In step S303, the apparatus distributes the received GPS L1 and GLONASS L1 signals.

Next, in step S305, the apparatus determines whether a switching command is generated.

In step S307, when it is determined that the switching command is not generated in to step S305, the apparatus converts the received GPS L1 and GLONASS L1 signals into IF and digital signals.

Next, in step S309, the apparatus performs signal tracking with respect to the converted IF and digital signals, and acquires signal processing information including code phase information, subcarrier phase information, navigation message information, Doppler frequency, timing information, and the like by utilizing a navigation message and ranging signals.

In step S311, the apparatus determines whether jamming signals are generated based on the acquired signal processing information.

Here, when the signal processing information acquired in step S311 includes an existing data range, the apparatus may determine that the jamming signals are not generated, and when the acquired signal processing information does not include the existing data range, the apparatus may determine that the jamming signals are generated.

In step S313, the apparatus generates a switching command when it is determined that the jamming signals are generated in step S311.

Alternatively, in step S315, the apparatus converts GLONASS L1 RF signals into GLONASS L1 IF signals when it is determined that the jamming signals are generated in step S305.

Next, in step S317, the apparatus processes the GLONASS L1 IF signals converted through step S315 to thereby acquire timing offset information.

That is, the apparatus acquires timing offset information between GPS and GLONASS based on timing information about the GLONASS navigation signals acquired by processing the GLONASS L1 IF signals in accordance with the signal processing information.

Next, in step S319, the apparatus processes the timing offset information between GPS and GLONASS systems acquired through step S317 together with position information about the GPS receiver installed in a fixed position such as a base station, which is stored before the jamming signals are generated, and then generates a GPS navigation message including time of week (TOW), transmission week no (WN), epoch for ephemeris & SV clock parameters (toe), signal health, an ephemeris & SV clock packet, an ionospheric correction parameter packet, and the like based on the position information.

Here, in order to obtain only accurate timing information, the apparatus inserts a minimum of four pieces of imitation satellite information based on disposition of satellites so that DOP of an available satellite with respect to satellite ephemeris information, satellite health state, and the like is superior, and extracts visual information including the timing information acquired by the GLONASS navigation receiver.

In step S321, the apparatus converts the navigation message generated in step S319 into IF and RF signals.

In step S323, the apparatus transmits, to the receiver installed in a fixed position such as a base station through the RF cable, the IF and RF signals converted in step S321, and acquires visual information using the transmitted IF and RF signals.

Therefore, according to the embodiments of the present invention, in the method for handling jamming signals using the apparatus for handling jamming signals, stable visual information may be acquired even in an environment in which jamming signals are generated, through the GLONASS L1 signals having a different navigation system in addition to a frequency band used by the GPS L1 signals.

As described above, according to the embodiments of the present invention, the method for handling jamming signals using the apparatus for handling jamming signals determines whether jamming signals are generated with respect to GPS navigation signals, and generates GPS navigation signals using the GLONASS navigation signal processing result based on the signal processing information when the jamming signals are generated.

Therefore, the GPS receiver installed in a fixed position may acquire stable visual information even in an environment in which jamming signals are generated.

While the example embodiments of the present invention and their advantages have been described in detail, it should be understood that various changes, substitutions and alterations may be made herein without departing from the scope of the invention.

What is claimed is:

1. An apparatus for handling jamming signals, comprising:
a first frequency conversion unit that converts a radio frequency (RF) signal of a first satellite into an intermediate frequency (IF) signal;
a signal processing unit that acquires signal processing information by performing signal tracking with respect to the converted IF signal;
a jamming determination unit that determines whether a jamming signal is generated based on the acquired signal processing information; and
a signal complex processing unit that performs signal processing with respect to an RF signal of a second satellite based on the signal processing information to thereby generate a navigation message of the first satellite when the jamming signal is generated.

2. The apparatus of claim 1, further comprising:
a reception unit that receives the RF signal of the first satellite and the RF signal of the second satellite;
a signal distribution unit that provides the RF signal of the first satellite and the RF signal of the second satellite;
a switching unit that performs switching with respect to the RF signal of the first satellite and the RF signal of the second satellite based on a control of the jamming determination unit; and
a second frequency conversion unit that converts the navigation message of the first satellite into an RF signal.

3. The apparatus of claim 1, wherein the signal processing unit performs the signal tracking with respect to the converted IF signal, acquires the signal processing information including at least one of code phase information, subcarrier phase information, navigation message information, Doppler frequency, and timing information by utilizing the navigation message and a ranging signal, and provides the acquired signal processing information.

4. The apparatus of claim 1, wherein the signal complex processing unit converts the RF signal of the second satellite into an IF signal, acquires timing offset information between the RF signal of the second satellite and the RF signal of the first satellite, and generates the navigation message of the first satellite including at least one of time of week (TOW), transmission week no (WN), epoch for ephemeris & SV clock parameters (toe), signal health, an ephemeris & SV clock packet, and an ionospheric correction parameter packet based on position information of the first satellite stored before the acquired timing offset information and the jamming signal are generated.

5. The apparatus of claim 2, wherein the jamming determination unit controls the switching unit so that the RF signal of the first satellite is provided to the first frequency conversion unit when the jamming signal is not generated, and controls the switching unit so that the RF signal of the second satellite is provided to the signal complex processing unit when the jamming signal is generated.

6. A method for handling jamming signals which is performed in an apparatus for handling jamming signals, the method comprising:
converting an RF signal of a first satellite into an IF signal;
acquiring signal processing information by performing signal tracking with respect to the converted IF signal;
determining whether a jamming signal is generated based on the acquired signal processing information; and
performing signal processing with respect to an RF signal of a second satellite based on the signal processing information to thereby generate a navigation message of the first satellite when the jamming signal is generated.

7. The method of claim 6, further comprising:
receiving the RF signal of the first satellite and the RF signal of the second satellite;
distributing the RF signal of the first satellite and the RF signal of the second satellite;
performing switching with respect to the distributed RF signal of the first satellite and the distributed RF signal of the second satellite; and
converting the navigation message of the first satellite into an RF signal.

8. The method of claim 6, wherein the determining includes performing the signal tracking with respect to the converted IF signal, acquiring the signal processing information including at least one of code phase information, subcarrier phase information, navigation message information, Doppler frequency, and timing information by utilizing the navigation message and a ranging signal, and determining whether the jamming signal is generated based on the acquired signal processing information.

9. The method of claim 6, wherein the performing of the signal processing includes converting the RF signal of the second satellite into an IF signal, acquiring timing offset information between the RF signal of the second satellite and the RF signal of the first satellite, and generating the navigation message of the first satellite including at least one of TOW, transmission WN, epoch for ephemeris & SV clock parameters (toe), signal health, an ephemeris & SV clock packet, and an ionospheric correction parameter packet based on position information of the first satellite stored before the acquired timing offset information and the jamming signal are generated.
